(19) United States
(12) Patent Application Publication
(10) Pub. No.: US 2025/0299200 A1
(43) Pub. Date: Sep. 25, 2025

(54) FINANCIAL SERVICE LOCATION SYSTEM AND METHOD PERFORMED BY FINANCIAL SERVICE LOCATION SYSTEM

(71) Applicant: Glory Ltd., Himeji-shi (JP)

(72) Inventors: Norishige INOUE, Himeji-shi (JP); Koji ARIMIZU, Himeji-shi (JP); Mitsunobu MANABE, Himeji-shi (JP); Katsuhiko MATSUMOTO, Himeji-shi (JP); Yuichi KITAMURA, Himeji-shi (JP)

(73) Assignee: Glory Ltd., Himeji-shi, Hyogo (JP)

(21) Appl. No.: 19/057,994

(22) Filed: Feb. 20, 2025

(30) Foreign Application Priority Data
Mar. 19, 2024 (JP) 2024-043273

(51) Int. Cl. G06Q 30/015

(52) U.S. Cl. CPC G06Q 30/015

(57) ABSTRACT

A financial service location system for use in a financial service location includes a visit reception device operable by a customer and a plurality of types of transaction processors that each perform different transaction processing according to the purpose. The visit reception device includes a reception unit that receives the purpose of the customer's visit, and a guidance unit that guides the customer to a target transaction processor corresponding to the purpose of the customer's visit among the plurality of types of transaction processors.

### CROSS-REFERENCE TO RELATED APPLICATION

The present application claims priority to Japanese Patent Application No. 2024-043273, filed in Japan on Mar. 19, 2024, the contents of which are hereby incorporated by reference in their entirety.

### BACKGROUND

### 1. Field

The present disclosure relates to a financial service location system and a method performed by the financial service location system.

### 2. Description of the Related Art

For example, in the financial service location system disclosed in JP 2006-133827A, a customer informs a business office attendant (referred to as a “person in charge” in the literature) of the purpose of the customer's visit, and the attendant guides the customer to a transaction processor (referred to as an “ATM” in the literature) according to the purpose of the customer's visit. Conventionally, banks have had tellers and the like on-site, but in recent years, banks have been reducing staff in their service locations due to factors such as labor shortages, work-style reforms, and low-profit structures. For this reason, attendants of a financial institution are stationed at desired locations, and a customer visiting an end-user service location can interact with a relevant advisor remotely or the like, resulting in greater efficiency in business operations. On the other hand, if a customer is not familiar with operating a transaction processor, the customer may not know which transaction processor to use when visiting a service location. Additionally, in service locations with reduced staff or unmanned service locations, customers may become confused about where to go within the service location. In this type of case, there is a risk that a customer will mistakenly use a transaction processor that is being used by another customer, causing confusion among users. An object of the present disclosure is to provide a financial service location system according to which it is possible to smoothly guide customers, and a method according to which it is possible to smoothly guide customers.

### SUMMARY

As a means for solving the above-described problem, a financial service location system according to a first aspect of the present disclosure is a financial service location system for use in a financial service location, including: a visit reception device operable by a customer; and a plurality of types of transaction processors each configured to perform different transaction processing according to a purpose,
in which the visit reception device includes:
   a reception unit configured to receive a purpose of the customer's visit; and
   a guidance unit configured to guide the customer to a target transaction processor corresponding to the purpose of the customer's visit among the plurality of types of transaction processors:

In one preferred embodiment of the present disclosure,
the plurality of types of transaction processors include:
   a service location-side customer service device configured to transmit information regarding a verification document of the customer to a customer service terminal operated by an attendant at a remote location, and receive information to be handed over to the customer from the customer service terminal; and
   a money handling device operable by the customer and configured to handle deposit and withdrawal of money.

In one preferred embodiment of the present disclosure,
at least one of the plurality of types of transaction processors enables remote interaction with an attendant at a remote location by being connected to a customer service terminal operated by the attendant.

In one preferred embodiment of the present disclosure, at least one of the transaction processors includes a first authentication information obtainer configured to acquire information for identity verification from the customer.

In one preferred embodiment of the present disclosure,
the visit reception device further includes:
   a second authentication information obtainer configured to acquire information for identity verification from the customer; and
   a medium issuer configured to issue a medium bearing information specifying the customer.

In one preferred embodiment of the present disclosure,
the second authentication information obtainer includes a camera configured to capture an image of a proof of identity of the customer.

In one preferred embodiment of the present disclosure,
the transaction processor is in a section isolated from others within the financial service location,
the financial service location system further includes a detector capable of detecting presence of a person in a detection region within the section, and
the guidance unit is configured to guide a second customer who is waiting for a turn to the target transaction processor, in response to a first customer finishing using the target transaction processor and the person not being detected in the detection region by the detector.

In one preferred embodiment of the present disclosure,
the financial service location system further includes an image capture unit provided within the section and configured to capture an image of the person,
in which the detector is configured to detect the person in the detection region based on the image captured by the image capture unit.

In one preferred embodiment of the present disclosure,
the detector is configured to detect a headcount of the person in the detection region based on the captured image.

As a means for solving the above-described problem, a method according to a second aspect of the present disclosure is a processing method to be performed by a financial service location system including a visit reception device operable by a customer and a plurality of types of transaction processors each configured to execute different transaction processing according to a purpose, the method including:
a reception step of receiving a purpose of the customer's visit; and
a guidance step of guiding the customer to a target transaction processor corresponding to the purpose of the customer's visit among the plurality of types of transaction processors.

The present disclosure provides a financial service location system according to which it is possible to smoothly guide customers, and a method according to which it is possible to smoothly guide customers.

The following detailed description of embodiments referring to the drawings will further clarify the above-described embodiments, other embodiments, procedures, features, functions, and effects relating to the present disclosure.

### BRIEF DESCRIPTION OF THE DRAWINGS

FIG. 1 is a plan view showing an example of a layout of a financial service location.

FIG. 2 is a block diagram showing a financial service location system.

FIG. 3 is a flow chart showing a flow of primary reception.

FIG. 4 is a diagram showing a flow of actions of a customer and automatic processing in primary reception.

FIG. 5 is a flow chart showing a flow when a customer is guided into a section.

FIG. 6 is a diagram showing a flow of actions of a customer being guided to a remote customer service section, and automatic processing.

FIG. 7 is a diagram showing a flow of actions of a customer being guided to a self-service deposit and withdrawal section, and automatic processing.

### DETAILED DESCRIPTION OF PREFERRED EMBODIMENTS

Hereinafter, a financial transaction system according to the present disclosure will be described with reference to the accompanying drawings. Note that the present disclosure is not limited to the following embodiments, and various modifications are possible without departing from the spirit and scope of the present disclosure.

### [Layout of Financial Service Location]

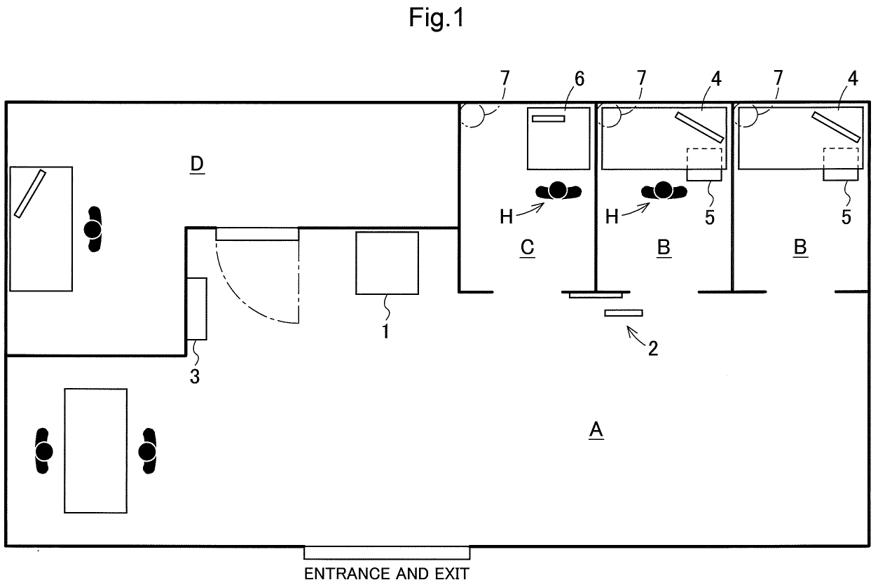

FIG. 1 shows an example of a financial service location such as a branch or a branch office of a bank. The financial service location illustrated in FIG. 1 has a lobby A, a remote customer service section B, a self-service deposit and withdrawal section C, and a back yard D. A service location staff member is stationed in the back yard D. In addition, a service location staff member may be stationed near the entrance of the lobby A as well.

An automated teller machine 1 (ATM) is disposed in the lobby A. The automated teller machine 1 is used by individual customers to deposit cash into and withdraw cash from deposit accounts. The automated teller machine 1 is connected to an accounting system server via an intra-bank network in such a manner as to be able to perform data communication therewith. When cash is deposited or withdrawn at the automated teller machine 1, account update processing is also carried out automatically. In addition to the automated teller machine 1, an automatic money change machine and an automatic tax and public fee payment machine may also be provided in the lobby A.

A visit reception device 2 is disposed in the lobby A. The visit reception device 2 is a device for handling primary reception of a customer visiting the financial service location, and is operated by the customer. For example, regarding cases that cannot be handled by the automated teller machine 1, the customer interacts with a remote customer service representative through the visit reception device 2 and is guided to the remote customer service section B, the self-service deposit and withdrawal section C, or the like as needed.

The lobby A also includes a deposit locker 3. The deposit locker 3 includes a non-volatile memory (not shown) that stores a program, and a processor (not shown) that executes the program, and is capable of performing various types of control in accordance with the program. The processor can be realized by an FPGA (field-programmable gate array), a GPU (graphics processing unit), an ASIC (application-specific integrated circuit), an ASSP (application-specific standard product), or a combination of two or more circuits selected from among these circuits, in addition to a CPU (central processing unit). When the program is executed by the processor, various functions of the deposit locker 3 are realized. The program may be constituted by, for example, an executable program generated by a compiler and a linker, or may be constituted by code that is executed sequentially by an interpreter. The deposit locker 3 is a lock-equipped locker for customers to deposit articles such as documents required for various notifications and the like. For example, if the remote customer service section B is fully booked and has no vacancy, or if the procedure takes time to complete, the customer is guided by the customer service representative for primary reception, who interacts through the visit reception device 2, to deposit an article such as a document in the deposit locker 3. Articles such as documents deposited in the deposit locker 3 are collected by a service location staff member at the financial service location, digitized using a scanner or the like, and then sent to headquarters, a center, or the like to be subjected to stamping, approval, and the like. Then, the finished product, which has been subjected to stamping, approval, and the like, is placed in the deposit locker 3 by the service location staff member. The customer is notified by, for example, a short message on a mobile terminal, that a procedure such as paperwork has been completed, and returns to the service location to retrieve the finished product from the deposit locker 3.

The remote customer service section B takes up an area of 2 to 3 square meters. In the remote customer service section B, a remote customer service device 4, a small money handling device 5, and an image capture unit 7 are arranged. That is, the remote customer service device 4 is provided in a section isolated from others within the financial service location.

An interactive display 4A of the remote customer service device 4 displays a customer service representative (an attendant in charge, etc.) at a remote location. In the remote customer service section B, the customer interacts with the customer service representative at the remote location displayed on the interactive display 4A and consults with the customer service representative about opening a savings account, changing the name on an account, closing an account, transferring money, paying taxes and public fees, depositing foreign currency, investment trusts, testamentary trusts, estate settlement, insurance, defined contribution pension plans, various types of loans, and the like. The image capture unit 7 captures an image of the inside of the remote customer service section B. Therefore, the image capture unit 7 captures an image of a person H in the section.

In the self-service deposit and withdrawal section C, a large money handling device 6 and the above-described image capture unit 7 are arranged. That is, the large money handling device 6 is provided in a section isolated from others within the financial service location.

In addition to transactions that can be processed by the automated teller machine 1 (ATM), the large money handling device 6 can also perform large cash transactions (deposit, withdrawal, exchange, etc.) that cannot be processed by the automated teller machine 1 (ATM) or the small money handling device 5.

The large money handling device 6 identifies and counts banknotes and coins, classifies them by type, and stores them inside. In addition, the large money handling device 6 stores therein bound notes each constituted by a predetermined number of banknotes (e.g., 100 banknotes) for each banknote type, and stores therein wrapped coins each constituted by a predetermined number of coins (e.g., 50 coins) for each coin type. Wrapped coins are a set of coins of the same type wrapped in a wrapping medium such as paper or film, and are also known as a “roll of coins”. For this reason, the large money handling device 6 is capable of depositing, dispensing, and exchanging a large number of banknotes and coins.

The remote customer service device 4 and the large money handling device 6 correspond to “transaction processors” of the present disclosure, which each execute different transaction processing according to the purpose. That is, the present disclosure includes a plurality of types of transaction processors.

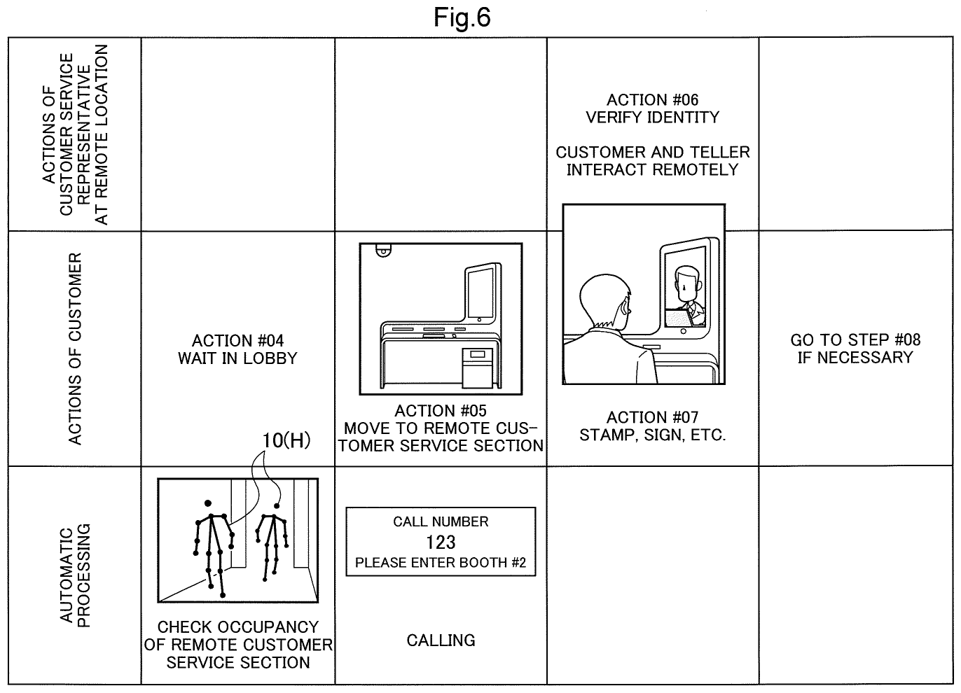

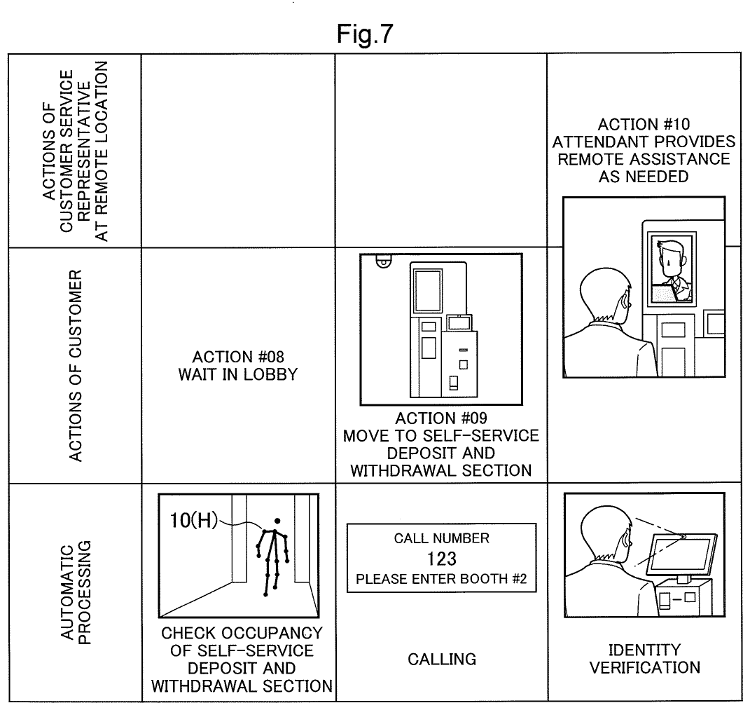

The image capture unit 7 captures an image of the inside of each of the remote customer service section B and the self-service deposit and withdrawal section C. As a result, each the image capture unit 7 captures an image of the person H (see FIGS. 6 and 7) in the section.

In response to an alarm or error occurring in the remote customer service device 4, the small money handling device 5, the large money handling device 6, or the like, the service location staff member in the back yard D performs work to recover from the alarm state or error state. Examples of such alarms and errors include running out of printing ink, toner, paper, or the like, or the remaining amount of money stocked in the small money handling device 5 and the large money handling device 6 being low.

### [Financial Service Location System]

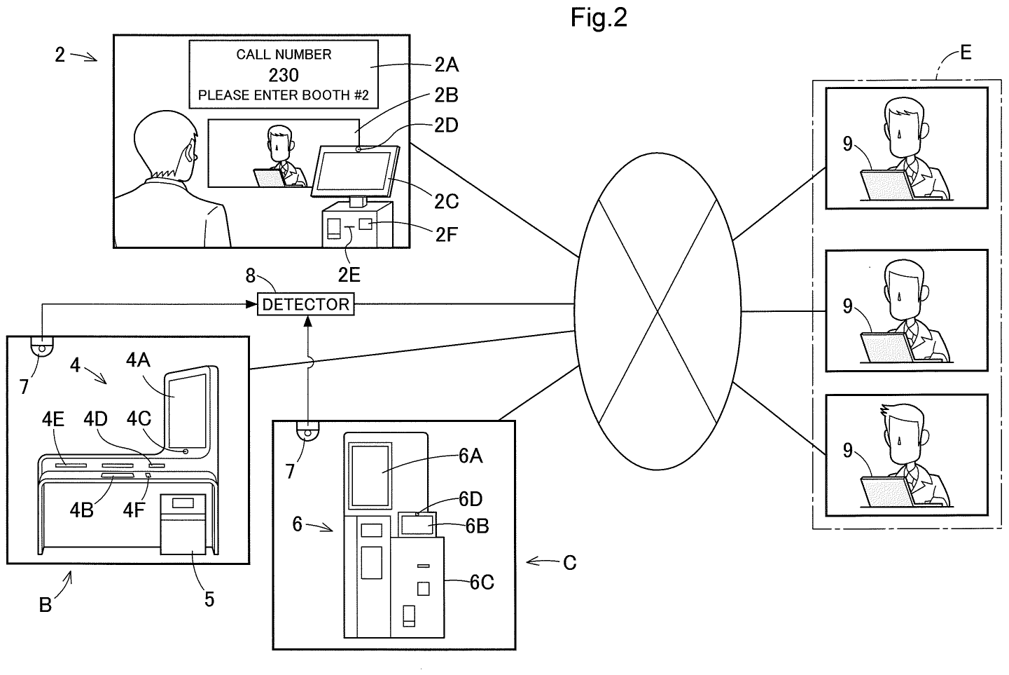

As shown in FIG. 2, the financial service location system includes the visit reception device 2, the remote customer service device 4, the small money handling device 5, the large money handling device 6, the image capture unit 7, a detector 8, and a customer service terminal 9. Each of the visit reception device 2, the remote customer service device 4, the small money handling device 5, the large money handling device 6, the image capture unit 7, the detector 8, and the customer service terminal 9 has a data communication module and is connected via a LAN or wide area network within each facility to enable communication (enable sending and receiving video, audio, and other data). The LAN within each facility may include wired communication conforming to a communication standard such as IEEE 1394 or Ethernet. In addition, the LAN in each facility may include wireless communication (Bluetooth, Wi-Fi, etc.) conforming to a communication standard such as IEEE 802. The wide area communication network may include, for example, a broadband Internet communication network using optical fiber cables, and a mobile communication system such as 4G or 5G. The customer service terminal 9 is installed in a remote customer service center E provided in a main service location or a dedicated center. A customer service representative is stationed in the remote customer service center E to serve customers via a customer service terminal 9. Through the customer service terminal 9, the customer service representative can serve customers at the financial service location and can also remotely operate the devices (the small money handling device 5, the large money handling device 6, etc.) installed at the financial service location. The detector 8 may be configured as a program system implemented in a management computer within the service location, or may be configured as a program system implemented in a server computer at a data center or the like at a remote location.

Note that a plurality of remote customer service devices 4 may be provided. The small money handling device 5 is provided adjacent to the remote customer service device 4. For this reason, a plurality of small money handling devices 5 may be provided corresponding to a plurality of remote customer service devices 4. In addition, a plurality of large money handling devices 6 may be provided. Furthermore, a plurality of image capture units 7 may be provided.

The visit reception device 2 is disposed in the lobby A. The visit reception device 2 includes a guidance display 2A, an interactive display 2B, an operation display 2C, a sensor camera 2D, a medium issuer 2E, and a reader 2F. Also, the visit reception device 2 includes a controller (not shown) that controls each component of the visit reception device 2. The controller includes a non-volatile memory (not shown) that stores a program, and a processor (not shown) that executes the program, and is capable of executing various types of control in accordance with the program. The processor can be realized by an FPGA (field-programmable gate array), a GPU (graphics processing unit), an ASIC (application-specific integrated circuit), an ASSP (application-specific standard product), or a combination of two or more circuits selected from among these circuits, in addition to a CPU (central processing unit). When the program is executed by the processor, various functions of the visit reception device 2 are realized. The program may be constituted by, for example, an executable program generated by a compiler and a linker, or may be constituted by code that is executed sequentially by an interpreter. The interactive display 2B and the operation display 2C correspond to a “reception unit” that receives the purpose of a customer's visit. The guidance display 2A corresponds to a “guidance unit” that guides a customer to a target transaction processor corresponding to the purpose of the customer's visit among a plurality of types of transaction processors.

The customer's eyes are located between upper and lower ends of the interactive display 2B. When serving a customer, the face of the customer service representative for primary reception is displayed on the interactive display 2B. Also, information such as the occupancy status of people in the remote customer service section B, the occupancy status of people in the self-service deposit and withdrawal section C, and call messages is displayed on the guidance display 2A.

The sensor camera 2D is adjacent to the operation display 2C. The sensor camera 2D captures an image of the customer, and the image of the face of the customer captured by the sensor camera 2D is displayed on the display of the customer service terminal 9 of the customer service representative for primary reception.

The medium issuer 2E issues a transaction number ticket showing a reception number.

The reader 2F acquires information for identity verification from the customer. That is, the reader 2F corresponds to a “second authentication information obtainer”. For example, the reader 2F is a camera that captures an image of a customer's identity verification document or proof of identity. The reader 2F may be a non-contact card reader, and may read information relating to identity verification from a proof of identity (e.g., a driver's license, a personal number card, etc.) equipped with an IC chip.

The remote customer service device 4 corresponds to a “service location-side customer service device”. The remote customer service device 4 includes an interactive display 4A, a tabletop display 4B, a sensor camera 4C, a card reader 4D, a document scanner 4E, and a seal scanner 4F. Also, the remote customer service device 4 includes a controller (not shown) that controls each component of the remote customer service device 4. The controller includes a non-volatile memory (not shown) that stores a program, and a processor (not shown) that executes the program, and is capable of executing various types of control in accordance with the program. The processor can be realized by an FPGA (field-programmable gate array), a GPU (graphics processing unit), an ASIC (application-specific integrated circuit), an ASSP (application-specific standard product), or a combination of two or more circuits selected from among these circuits, in addition to a CPU (central processing unit). When the program is executed by the processor, various functions of the remote customer service device 4 are realized. The program may be constituted by, for example, an executable program generated by a compiler and a linker, or may be constituted by code that is executed sequentially by an interpreter.

A customer service representative (an attendant in charge, etc.) at a remote location (remote customer service center E) is displayed on the interactive display 4A. The tabletop display 4B displays, for example, shared documentation, contract documents, and the like presented by the customer service representative. Note that the tabletop display 4B also has a touch panel function, allowing the customer to affix an electronic signature to the contract document displayed on the tabletop display 4B using a touch pen or the like.

The sensor camera 4C captures an image of the customer, and the face of the customer captured by the sensor camera 4C is displayed on the display of the customer service terminal 9 of the customer service representative in charge.

The card reader 4D reads information from a customer's bankbook, cash card, or the like. The document scanner 4E reads customer application documents, contract documents, bankbooks, and the like as image data. The seal scanner 4F reads a seal impression of the customer's seal. When the customer presses the seal surface against the reading portion of the seal scanner 4F as if stamping a piece of paper, the seal impression of the seal is read. At this time, the bank seal registered on the customer's account is automatically matched with the seal impression read by the seal scanner 4F.

In this way, the remote customer service device 4 enables remote interaction with the customer service representative by being connected to the customer service terminal 9 operated by the customer service representative (the attendant in charge, etc.) at the remote location. In addition, the remote customer service device 4 transmits information regarding the customer's verification documents to the customer service terminal 9 operated by the customer service representative at the remote location, and receives, from the customer service terminal 9, information to be handed over to the customer.

The small money handling device 5 is disposed next to the remote customer service device 4. The small money handling device 5 includes a non-volatile memory (not shown) that stores a program, and a processor (not shown) that executes the program, and is capable of executing various types of control in accordance with the program. The processor can be realized by an FPGA (field-programmable gate array), a GPU (graphics processing unit), an ASIC (application-specific integrated circuit), an ASSP (application-specific standard product), or a combination of two or more circuits selected from among these circuits, in addition to a CPU (central processing unit). When the program is executed by the processor, various functions of the small money handling device 5 are realized. The program may be constituted by, for example, an executable program generated by a compiler and a linker, or may be constituted by code that is executed sequentially by an interpreter. The small money handling device 5 enables deposit and withdrawal of, for example, less than one million yen in cash. The small money handling device 5 is remotely operated by a customer service representative at a remote location. Note that the small money handling device 5 may also be operated by a customer.

The large money handling device 6 is operated by a customer and processes the deposit and withdrawal of money. The large money handling device 6 includes an interactive display 6A, an operation display 6B, a money handling unit 6C, and a sensor camera 6D. Also, the large money handling device 6 includes a controller (not shown) that controls each component of the large money handling device 6. The controller includes a non-volatile memory (not shown) that stores a program, and a processor (not shown) that executes the program, and is capable of executing various types of control in accordance with the program. The processor can be realized by an FPGA (field-programmable gate array), a GPU (graphics processing unit), an ASIC (application-specific integrated circuit), an ASSP (application-specific standard product), or a combination of two or more circuits selected from among these circuits, in addition to a CPU (central processing unit). When the program is executed by the processor, various functions of the large money handling device 6 are realized. The program may be constituted by, for example, an executable program generated by a compiler and a linker, or may be constituted by code that is executed sequentially by an interpreter. The operation display 6B has a touch panel function, and a customer operates the large money handling device 6 using the operation display 6B.

A “call attendant” touch button is displayed on the operation display 6B. When the customer touches the “call attendant” touch button, the attendant in charge will be displayed on the interactive display 6A. Also, the sensor camera 6D captures an image of the customer, and the image of the face of the customer captured by the sensor camera 6D is displayed on the display of the customer service terminal 9 of the attendant. For this reason, even if a customer is unfamiliar with operating the large money handling device 6, the customer can receive assistance in operating the large money handling device 6 while interacting with the attendant. In this way, the large money handling device 6 enables remote interaction with the attendant at the remote location by being connected to the customer service terminal 9 operated by the attendant. In addition to assistance through remote conversation, the attendant can also remotely operate the large money handling device 6 via the customer service terminal 9.

When identity verification is performed in the large money handling device 6, the sensor camera 6D acquires information for identity verification from the customer. For example, the sensor camera 6D captures an image of the customer's identity verification document or proof of identity. That is, the sensor camera 6D corresponds to a “first authentication information obtainer”. The large money handling device 6 may include a card reader and a document scanner for acquiring information for identity verification.

### [Flow of Primary Reception]

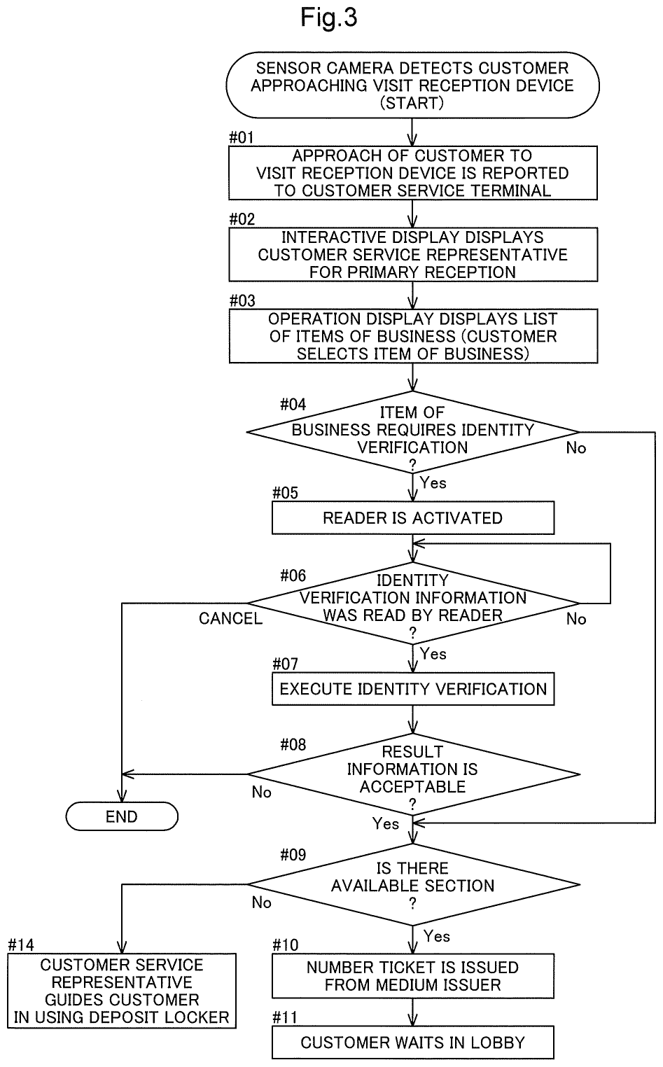

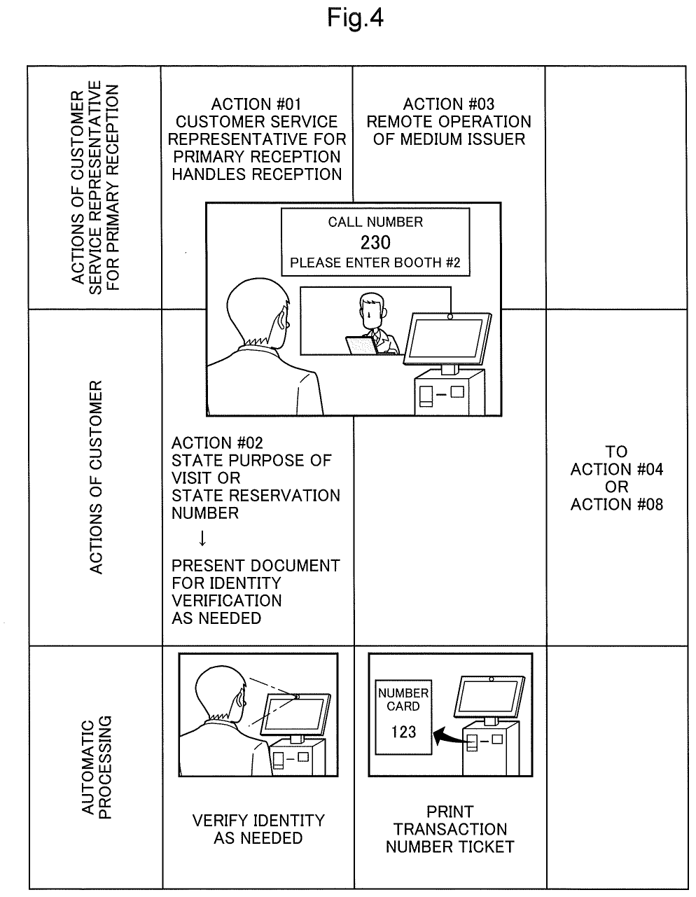

The flow of primary reception in this embodiment will be described with reference to FIGS. 3 and 4. Note that a mode in which identity verification is performed by the visit reception device 2 will be described. When the sensor camera 2D detects a customer approaching the visit reception device 2 (start of FIG. 3), a notification signal is transmitted from the visit reception device 2 to the customer service terminal 9 of the customer service representative for primary reception (step #01 of FIG. 3).

The customer service terminal 9 is, for example, a notebook computer including a camera and a microphone, and is installed at headquarters, a customer service center, or the like. The customer service terminal 9 includes a non-volatile memory (not shown) that stores a program, and a processor (not shown) that executes the program, and is capable of executing various types of control in accordance with the program. The processor can be realized by an FPGA (field-programmable gate array), a GPU (graphics processing unit), an ASIC (application-specific integrated circuit), an ASSP (application-specific standard product), or a combination of two or more circuits selected from among these circuits, in addition to a CPU (central processing unit). When the program is executed by the processor, various functions of the customer service terminal 9 are realized. The program may be constituted by, for example, an executable program generated by a compiler and a linker, or may be constituted by code that is executed sequentially by an interpreter. The customer service representative is stationed near the customer service terminal 9. In response to the notification signal transmitted from the visit reception device 2, the customer service terminal 9 notifies the customer service representative by displaying a screen, by audio, or the like. Then, remote interactive communication is established between the customer service terminal 9 and the visit reception device 2, and the customer service representative for primary reception is displayed on the guidance display 2A (step #02 in FIG. 3). At this time, the customer service representative for primary reception handles reception of the customer (action #01 in FIG. 4).

Then, a list of items of business related to the purpose of the customer's visit is displayed on the operation display 2C (step #03 in FIG. 3). The operation display 2C is a touch panel display that can be operated by the customer. The list of items of business is displayed as touch panel buttons on the operation display 2C.

The customer states the customer service representative for primary reception the purpose of the visit or a reservation number (action #02 in FIG. 4). At this time, the operation display 2C may be remotely operated by the customer service representative to select the customer's desired item of business. Alternatively, the customer may select the desired item of business while operating the operation display 2C.

The list of items of business displayed on the operation display 2C includes items of business that require customer identity verification. For this reason, when the customer selects a desired item of business from the list of items of business displayed on the operation display 2C, it is determined whether or not the item of business requires identity verification (step #04 in FIG. 3). If the item of business does not require identity verification (step #04 in FIG. 3: No), the processing proceeds to step #09, which will be described later.

If the item of business requires identity verification (step #04 in FIG. 3: Yes), the reader 2F is activated and becomes available for use (step #05 in FIG. 3).

When the reader 2F is activated, the customer holds his or her proof of identity over the reader 2F, and it is determined whether or not the identity verification information has been read by the reader 2F (step #06 in FIG. 3). If the identity verification information has not been read by the reader 2F (step #06 in FIG. 3: No), the determination processing of step #06 is repeated.

Note that it is conceivable that the reading in the reader 2F is canceled due to a cancel operation performed by the customer, a timeout, or another factor. In such a case (step #06 in FIG. 3: Cancel), the processing of the flow chart shown in FIG. 3 ends.

When the identity verification information is read by the reader 2F (step #06 in FIG. 3: Yes), identity verification is performed (step #07 in FIG. 3). For example, a primary reception customer service representative determines whether or not the face information acquired from the proof of identity by the reader 2F matches the image of the face of the customer captured by the sensor camera 2D. Such identity verification may be performed automatically by the visit reception device 2, or may be performed by an authentication server in a data center or the like. Then, it is determined whether the result information indicative of the result of the identity verification is acceptable or unacceptable (step #08 in FIG. 3).

If the result information is unacceptable, it means that the customer's identity could not be verified. If the result information of the identity verification is unacceptable (step #08 in FIG. 3: No), the processing of the flow chart shown in FIG. 3 ends.

If the result information of the identity authentication is acceptable (step #08 in FIG. 3: Yes), it is determined whether or not there is an available remote customer service section B or self-service deposit and withdrawal section C within the financial service location according to the customer's purpose (step #09 in FIG. 3). The processing for determining whether or not there is an available section may be executed by the visit reception device 2 or the management server, or may be executed by the primary reception customer service representative.

If the remote customer service section B and the self-service deposit and withdrawal section C are occupied or are fully booked and there is no vacancy (step #09 in FIG. 3: No), the customer is guided by the customer service representative interacting through the visit reception device 2 to deposit a document or the like in the deposit locker 3 (step #14 in FIG. 3). Note that although not shown in the flow chart of FIG. 3, even if the customer's item of business requires time to complete in terms of procedure, the customer is guided by the customer service representative interacting through the visit reception device 2 to deposit a document or the like in the deposit locker 3.

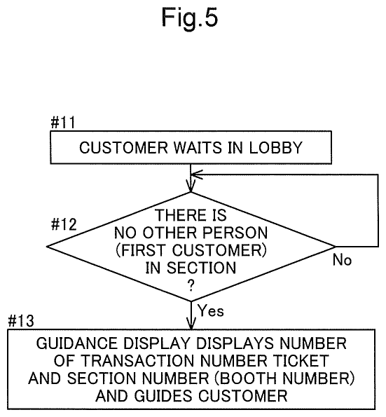

If there is an available section according to the customer's purpose (step #09 in FIG. 3: Yes), the customer service representative for primary reception remotely operates the medium issuer 2E (action #03 in FIG. 4), and a transaction number ticket is issued by the medium issuer 2E (step #10 in FIG. 3). The transaction number ticket displays a reception number. Here, the interaction between the customer and the customer service representative ends, and the customer waits in the lobby A with the transaction number ticket in hand (action #04 in FIG. 6 or action #08 in FIG. 7, step #11 in FIGS. 3 and 5).

Note that, for example, a graphic code (e.g., a QR code, a data matrix, a bar code, a color code, etc.) may also be printed on the transaction number ticket. If a graphic code is printed on the transaction number ticket, the customer may be enabled to use the remote customer service device 4 or the large money handling device 6 by holding the graphic code over a reader of the remote customer service device 4 or the large money handling device 6. In this embodiment, information for specifying a customer (e.g., a graphic code such as a QR code, a data matrix, a barcode, or a color code) is printed on the transaction number ticket. By having the sensor camera 4C of the remote customer service device 4 or the sensor camera 6D of the large money handling device 6 read this graphic code, the person operating the remote customer service device 4 or the large money handling device 6 is specified as a customer whose identity has been verified. This makes it possible to omit identity verification at the remote customer service device 4 and the large money handling device 6. That is, the medium issuer 2E issues a transaction number ticket (medium) bearing information for specifying the customer.

### [Processing for Confirming Occupancy of Section]

While the customer is waiting in the lobby A (action #04 in FIG. 6 or action #08 in FIG. 7, step #11 in FIG. 5), it is determined whether or not there is another person (first customer) in the target section based on image data captured by the image capture unit 7 (step #12 in FIG. 5). The detector 8 is capable of detecting occupancy of a person H in a detection region within a section. Specifically, the detector 8 can detect the person H in the detection region within the section from the image data through the above-mentioned skeleton recognition processing. If another person (first customer) is present in the target section (step #12 in FIG. 5: No), the customer (first customer) waits in the state of step #11, and the determination of step #12 is repeated.

As described above, the image capture unit 7 captures an image of the inside of the section. In this embodiment, the image capture unit 7 is constituted by an infrared camera. However, the present disclosure is not limited to this, and the image capture unit 7 may be any device other than an infrared camera as long as it is capable of capturing an image of the inside of the section. It is preferable that the image capture unit 7 is a ToF (Time of Flight) camera, since this makes it possible to detect the distance between the camera and the object. It is preferable that the captured image acquired by the image capture unit 7 is a depth image, which is an image including depth information. Note that the captured image acquired by the image capture unit 7 may be a moving image or a still image. In addition, due to confirmation being possible through comparison with a color image, the captured image may also be used for visual confirmation.

In the presence confirmation processing for the section shown in FIGS. 6 and 7, an example of a captured image acquired by the image capture unit 7 is shown. The detector 8 generates skeleton information 10 (see FIGS. 6 and 7) based on the captured image. The skeleton information 10 is information that indicates a skeleton model of the person H occupying the section. The skeleton model is generated by analyzing the captured images to recognize positions of joints of the person H in three dimensions and connecting the joints with straight lines. The detector 8 is also capable of detecting actions of the person H, such as walking, standing, or sitting, within the section, based on the skeleton information 10. In this embodiment, in response to the skeleton information 10 moving in a direction of leaving the section, the detector 8 detects the person H leaving the section.

In this manner, the detector 8 detects the person H in the detection region within the section based on an image captured by the image capture unit 7 capturing an image of the inside of the section. Also, a method of detection using a motion sensor or an image sensor may be used. In this case, there is a limit to the detection area, and fluctuations in the direction of movement of the person and the captured image have an influence. Skeleton recognition can eliminate this influence, enabling more accurate detection of the presence of a person.

When there is no longer another person (first customer) in the target section, the result of the determination performed in step #12 of FIG. 5 becomes Yes. Then, for example, when the customer service representative in charge (teller, etc.) is ready to interact with the customer (second customer), the number of the transaction number ticket and the section number (booth number) are displayed on the guidance display 2A, and the customer (second customer) is guided (step #13 of FIG. 5).

That is, the guidance display 2A guides the second customer who is waiting for a turn to the target transaction processor (one of either the remote customer service device 4 or the large money handling device 6) in response to the other person (the first customer) finishing using the target transaction processor and the person H not being detected by the detector 8 in the detection region within the target section.

If the customer wishes to consult with the customer service representative at the remote location in the remote customer service section B, the customer moves to the remote customer service section B (action #05 of FIG. 6). Then, the customer service representative at the remote location remotely interacts with the customer (action #06 of FIG. 6). At this time, the graphic code (information) attached to the transaction number ticket (medium) is read by the sensor camera 4C of the remote customer service device 4, whereby the person operating the remote customer service device 4 is specified as a customer whose identity has been verified.

Note that the remote customer service device 4 may also perform identity verification. In this case, the sensor camera 4C, the card reader 4D, or the document scanner 4E acquires information for identity verification from the customer. For example, the sensor camera 4C captures an image of the customer's identity verification document or proof of identity. The card reader 4D reads information regarding identity verification from a proof of identity (e.g., a driver's license, an individual number card, etc.) equipped with an IC chip. The document scanner 4E scans the customer's identity verification document or proof of identity to acquire an image. The customer's identity is verified by the customer service representative determining whether the information acquired in this manner matches the image of the face of the customer captured by the sensor camera 4C. Note that the identity verification may be performed automatically by the remote customer service device 4, or may be performed by an authentication server in a data center or the like. In this case, the sensor camera 4C, the card reader 4D, and the document scanner 4E correspond to a “first authentication information obtainer”. In this case, identity verification at the visit reception device 2 does not need to be performed. The visit reception device 2 does not need to include the reader 2F.

If necessary, the customer uses the seal scanner 4F to stamp a document or signs a document on the tabletop display 4B (action #07 of FIG. 6).

A case is conceivable in which a customer withdraws or deposits money based on transaction content determined through communication with the customer service representative at the remote location. If only a small amount needs to be deposited or withdrawn, the customer service representative at the remote location remotely operates the small money handling device 5 to hand over money to the customer or to receive money from the customer.

In the case of a large cash transaction that cannot be processed by the small money handling device 5, the communication between the customer and the remote customer service representative ends there, and the customer leaves the remote customer service section B and waits again in the lobby A for preparation to be completed at the self-service deposit and withdrawal section C (action #08 of FIG. 7). If there is no other person in the self-service deposit and withdrawal section C (step #12 in FIG. 5: Yes), the number of the transaction number ticket and the section number (booth number) are displayed on the guidance display 2A, and the customer (second customer) is guided (step #13 in FIG. 5).

The customer moves to the self-service deposit and withdrawal section C (action #09 of FIG. 7). At this time, by having the graphic code (information) on the transaction number ticket (medium) read by the sensor camera 6D of the large money handling device 6, the person operating the large money handling device 6 is specified as a customer whose identity has been verified.

Note that identity verification may also be performed at the large money handling device 6. In this case, the sensor camera 6D acquires information for identity verification from the customer. For example, the sensor camera 6D captures an image of the customer's identity verification document or proof of identity. The customer's identity is verified by the customer service representative determining whether or not the information acquired in this manner matches the image of the face of the customer captured by the sensor camera 6D. Note that identity verification may also be performed automatically by the large money handling device 6, or may be performed by an authentication server in a data center or the like. In this case, the sensor camera 6D corresponds to a “first authentication information obtainer”. In this case, identity verification at the visit reception device 2 does not need to be performed. The visit reception device 2 does not need to include the reader 2F.

When identity verification has been completed and the customer is able to operate the large money handling device 6, the customer deposits or withdraws money while operating the large money handling device 6 on the operation display 6B. At this time, in response to the remote attendant being called by the customer operating the operation display 6B, the attendant remotely supports the customer in operating the large money handling device 6 as needed (action #10 of FIG. 7).

### Actions and Effects of the Embodiment

The present disclosure relates to a financial service location system for use in a financial service location including the visit reception device 2 operable by a customer and a plurality of types of transaction processors (the remote customer service device 4 and the large money handling device 6) that each perform different transaction processing according to a purpose. The visit reception device 2 includes the operation display 2C (reception unit) that receives the customer's purpose for visiting the service location, and the guidance display 2A (guidance unit) that guides the customer to a target transaction processor corresponding to the purpose of the customer's visit among the plurality of types of transaction processors.

According to the present disclosure, the reception unit receives the purpose of the customer's visit, and the guidance unit guides the customer to the target transaction processor according to the purpose of the customer's visit. For this reason, even if the service location operates with reduced staff, a customer can use the appropriate transaction processor without being confused about where to go within the service location. In addition, the guidance unit guides the customer to the target transaction processor, thereby avoiding the risk of the customer mistakenly using a transaction processor that is being used by another person. This makes it possible to realize a financial service location system that can smoothly guide customers.

The plurality of types of transaction processors of the present disclosure include the remote customer service device 4 (service location-side customer service device) that transmits information regarding the customer's verification document to the customer service terminal 9 operated by an attendant at a remote location and receives information from the customer service terminal 9 to be handed over to the customer, and the large money handling device 6 (money handling device) that is operated by the customer and processes deposit and withdrawal of money.

With this configuration, even if the attendant is at a remote location, the attendant can understand the content of the customer's verification document and can provide the customer with a necessary document. In addition, even if the attendant is at a remote location, the attendant can use the money handling device to receive money from the customer and hand over money to the customer.

The plurality of types of transaction processors (the remote customer service device 4 and the large money handling device 6) of the present disclosure enable remote interaction with the attendant at the remote location by being connected to the customer service terminal 9 operated by the attendant.

This configuration enables smooth communication between the customer and the attendant.

The large money handling device 6 (transaction processor) of the present disclosure includes the sensor camera 6D (first authentication information obtainer) that acquires information for identity verification from the customer.

This configuration prevents a third party posing as a legitimate customer from using the transaction processor.

In the present disclosure, the visit reception device 2 includes the reader 2F (second authentication information obtainer) that acquires information for identity verification from the customer, and the medium issuer 2E that issues a medium bearing information specifying the customer.

This configuration enables the visit reception device 2 to perform identity verification. In addition, since the medium bearing information specifying the customer is issued, it is possible to omit identity verification at the transaction processor (remote customer service device 4, large money handling device 6) by using the medium.

The reader 2F (second authentication information obtainer) of the present disclosure includes a camera that captures an image of the customer's proof of identity.

This configuration makes it possible to verify the identity of the customer more reliably.

The transaction processors (the remote customer service device 4 and the large money handling device 6) of the present disclosure are provided in the sections B and C that are isolated from others within the financial service location, and include the detector 8 capable of detecting the presence of the person H in the detection region within the sections B and C. The guidance display 2A (guidance unit) guides a second customer who is waiting for a turn to the target transaction processor (one of either the remote customer service device 4 or the large money handling device 6) in response to the first customer finishing using the target transaction processor and the person H not being detected in the detection region by the detector 8.

This configuration more reliably prevents the second customer from mistakenly entering a section in which another person (first customer) is present.

The present disclosure includes the image capture unit 7 that is provided in the sections B and C and captures an image of the person H. The detector 8 is configured to detect the person H in the detection region based on the image captured by the image capture unit 7.

This configuration enables the detector 8 to automatically detect the person H from the image captured by the image capture unit 7. This more reliably prevents the second customer from mistakenly entering the section where another person (first customer) is present, even when no service location staff member is present.

### Other Embodiments

The present disclosure is not limited to the configurations described as examples in the above-described embodiments, and other representative embodiments of the present disclosure will be described as examples below.
(1) This disclosure is also applicable to a method to be performed by a financial service location system. The method is a processing method to be performed by the financial service location system including the visit reception device 2 operable by the customer and the plurality of types of transaction processors (the remote customer service device 4 and the large money handling device 6) that each perform different transaction processing according to the purpose. The method includes a reception step of receiving the purpose of the customer's visit, and a guidance step of guiding the customer to a target transaction processor corresponding to the purpose of the customer's visit among the plurality of types of transaction processors (the remote customer service device 4 and the large money handling device 6). Steps #01 to #03 shown in FIG. 3 are included in the reception step. In addition, step #13 shown in FIG. 5 is included in the guidance step. In the reception step, the purpose of the customer's visit is received, and in the guidance step, the customer is guided to the target transaction processor according to the purpose of the customer's visit. For this reason, even if the service location operates with reduced staff, the customer can use the appropriate transaction processor without being confused about where to go within the service location. Furthermore, guiding the customer to the target transaction processor in the guidance step avoids the risk of the customer mistakenly using a transaction processor that is being used by another person. This realizes a method according to which it is possible to smoothly guide customers.
(2) The reception unit may be constituted by, for example, only voice guidance provided by a customer service representative for primary reception who is at a remote location. In addition, the operation display 2C does not need to be included.
(3) The guidance display 2A and the interactive display 2B may be formed as an integrated display. In addition, the interactive display 2B and the operation display 2C may be formed as an integrated touch panel display. Furthermore, the guidance display 2A, the interactive display 2B, and the operation display 2C may be formed as an integrated touch panel display. In this case, the reception unit and the guidance unit may be integrally formed.
(4) There is no limitation to this embodiment, and the reception unit of the present disclosure may automatically determine the target transaction processor corresponding to the purpose of the customer's visit among the plurality of types of transaction processors. The reception unit may automatically determine the target transaction processor based on operation of the operation display 2C by the customer. For example, the visit reception device 2 may include an interactive AI chat function that analyzes the content of the customer's voice and text input to acquire information regarding the purpose of the customer's visit, and the reception unit may automatically determine the target transaction processor based on that information. Note that the reception unit of the present disclosure may automatically obtain the purpose of the customer's visit from a reservation system (not shown). In this case, the customer may input a reservation number into the operation display 2C, or have the sensor camera 2D scan a graphic code (e.g., a QR code, a data matrix, a bar code, a color code, etc.) that includes the reservation information.
(5) The plurality of types of transaction processors are not limited to the visit reception device 2 and the large money handling device 6. The plurality of types of transaction processors may also include the automated teller machine 1 (ATM) and the small money handling device 5.
(6) In the above-described embodiment, the sensor camera 4C of the remote customer service device 4 and the sensor camera 6D of the large money handling device 6 are illustrated as examples of the first authentication information obtainer. The first authentication information obtainer may also be only one of either the sensor camera 4C or the sensor camera 6D.
(7) A camera may be provided at the entrance to the remote customer service section B, and facial recognition may be performed using this camera to unlock a locked door at the entrance to the remote customer service section B.
(8) The entrance to the self-service deposit and withdrawal section C may be provided with an electrically locking door and a camera, and facial recognition may be performed using the camera to unlock the locked door at the entrance to the self-service deposit and withdrawal section C. Security of the self-deposit and withdrawal section C can be improved by locking the section before a customer enters and while operation is being performed.
(9) The guidance unit may be, for example, a display or a colored light provided in each of the remote customer service section B and the self-service deposit and withdrawal section C. For example, when another person is in the section, the guidance unit may display the presence of the other person on a display, or the guidance unit may give notification of the presence of the other person by changing the color of a colored light. Also, for example, if there is another person in a section, the guidance unit may change the color of the lighting in that section to prevent the customer from mistakenly entering the section.
(10) Amotion sensor may be provided instead of the image capture unit 7. In this case, the detector 8 may detect the person H in each of the detection regions of the remote customer service section B and the self-service deposit and withdrawal section C based on the detection result of the motion sensor. In addition, both the image capture unit 7 and the motion sensor may be provided, and the detector 8 may detect the person H based on the detection results of both the image capture unit 7 and the motion sensor.
(11) The detector 8 may detect a headcount of the person H based on the skeleton information 10 of the person H in the detection region within the section. That is, the detector 8 may be able to detect the headcount of the person H in the detection region based on the captured image. With this configuration, the person H in the section is reliably detected from the captured image. This more reliably avoids the risk that the second customer will mistakenly enter a section where another person (first customer) is present. Also, with this configuration, it is possible to register the fact that there are a plurality of people in a section, and it is possible to use a configuration in which people are reliably prompted to leave the section based on that headcount. Note that the detector 8 may notify a service location staff member that there are a plurality of users in the section, and prompt the service location staff member to check for safety.
(12) After the customer service representative for primary reception and the customer have communicated at the visit reception device 2, for example, a service location staff member stationed in the back yard D may take over and assist the customer. For example, when an alarm or error occurs in the remote customer service device 4, the small money handling device 5, the large money handling device 6, or the like, or when handling money that cannot be handled by the large money handling device 6 (e.g., old banknotes, special gold coins, foreign currency, etc.), the service location staff member may take over and assist the customer.

The configurations disclosed in the above embodiments (including the other embodiments, the same applies hereinafter) may be implemented by being combined with configurations disclosed in other embodiments as long as no contradiction arises. The embodiments disclosed in the present specification are examples, and embodiments of the present disclosure are not limited to the above embodiments. The disclosed embodiments can be modified as appropriate within a scope not departing from the object of the present disclosure.

The present disclosure is applicable to a financial service location system and a method to be performed by a financial service location system.

What is claimed is:

1. A financial service location system for use in a financial service location, comprising: a visit reception device operable by a customer; and a plurality of types of transaction processors each configured to perform different transaction processing according to a purpose,
wherein the visit reception device includes:
a reception unit configured to receive a purpose of the customer's visit; and
a guidance unit configured to guide the customer to a target transaction processor corresponding to the purpose of the customer's visit among the plurality of types of transaction processors.

2. The financial service location system according to claim 1, wherein
the plurality of types of transaction processors include:
a service location-side customer service device configured to transmit information regarding a verification document of the customer to a customer service terminal operated by an attendant at a remote location, and receive information to be handed over to the customer from the customer service terminal; and
a money handling device operable by the customer and configured to handle deposit and withdrawal of money.

3. The financial service location system according to claim 1, wherein
at least one of the plurality of types of transaction processors enables remote interaction with an attendant at a remote location by being connected to a customer service terminal operated by the attendant.

4. The financial service location system according to claim 1, wherein
at least one of the transaction processors includes a first authentication information obtainer configured to acquire information for identity verification from the customer.

5. The financial service location system according to claim 1, wherein
the visit reception device further includes:
a second authentication information obtainer configured to acquire information for identity verification from the customer; and
a medium issuer configured to issue a medium bearing information specifying the customer.

6. The financial service location system according to claim 5, wherein
the second authentication information obtainer includes a camera configured to capture an image of a proof of identity of the customer.

7. The financial service location system according to claim 1, wherein
the transaction processor is in a section isolated from others within the financial service location,
the financial service location system further comprises a detector capable of detecting presence of a person in a detection region within the section, and
the guidance unit is configured to guide a second customer who is waiting for a turn to the target transaction processor, in response to a first customer finishing using the target transaction processor and the person not being detected in the detection region by the detector.

8. The financial service location system according to claim 7, further comprising
an image capture unit provided within the section and configured to capture an image of the person,
wherein the detector is configured to detect the person in the detection region based on the image captured by the image capture unit.

9. The financial service location system according to claim 8, wherein
the detector is configured to detect a headcount of the person in the detection region based on the captured image.

10. A processing method to be performed by a financial service location system including a visit reception device operable by a customer and a plurality of types of transaction processors each configured to execute different transaction processing according to a purpose, the method comprising:
a reception step of receiving a purpose of the customer's visit; and
a guidance step of guiding the customer to a target transaction processor corresponding to the purpose of the customer's visit among the plurality of types of transaction processors.
